(19) United States
(12) Patent Application Publication
(10) Pub. No.: US 2026/0245167 A1
(43) Pub. Date: Aug. 20, 2026

(54) HYBRID IMAGE PROCESSOR AND LATENT DIFFUSION FRAMEWORK USING FLOATING LATENT SPACE PROJECTORS

(71) Applicant: Intel Corporation, Santa Clara, CA (US)

(72) Inventors: Noam Levy, Sunnyvale, CA (US); Dor Barber, Herzliya (IL)

(73) Assignee: Intel Corporation, Santa Clara, CA (US)

(21) Appl. No.: 19/641,807

(22) Filed: Apr. 8, 2026

(51) Int. Cl. G06T 1/20; G06T 7/246; G06T 11/60

(52) U.S. Cl. CPC G06T 1/20; G06T 7/246; G06T 11/60; G06T 2207/10016; G06T 2207/20081; G06T 2207/20084; G06T 2207/20212

(57) ABSTRACT

Systems and methods are provided for a hybrid image processing system that integrates latent diffusion model outputs into a hardware ISP pipeline through floating latent space projection operators. The system includes a latent projector that maps ISP image data into the latent space of a diffusion model, a latent merge block that combines the projected image representation with the diffusion model's output in the latent space, and a latent deprojector that converts the merged representation back to the image domain. The latent projector and deprojector are compact convolutional neural networks trained to approximate the variational autoencoder encoder and decoder of the diffusion model. Real-time operation is enabled through latent-domain computation, temporal subsampling of the diffusion model with latent-space interpolation, and static background masking. The system enables incorporation of AI-generated content into live video with high fidelity and temporal coherence.

### TECHNICAL FIELD

This disclosure relates generally to image processing, and in particular to hybrid image processing and latent diffusion using floating latent space projectors.

### BACKGROUND

Modern digital cameras capture images using an image sensor that produces raw image data, which is then processed through an image signal processing (ISP) pipeline. The ISP pipeline typically includes a series of sequential processing blocks that transform the raw sensor output into a viewable, high-quality image. The processing blocks perform operations including, for example, lens shading correction, white balance, defective pixel correction, spatial denoising, demosaicing, color matching, tone mapping, temporal denoising, sharpening, and local contrast enhancement. The ISP pipeline generally operates in the native image space (i.e., directly on pixel-level representations of the captured scene) and is commonly implemented in dedicated hardware to meet the throughput and latency of real-time video capture. Artificial intelligence techniques for generating and manipulating image and video content have advanced rapidly in recent years. However, integrating AI-generated or AI-edited content into a live camera pipeline remains impractical.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of a hybrid image processing system that integrates latent diffusion model outputs into a hardware image signal processing (ISP) pipeline, in accordance with various embodiments.

FIG. 2 is a block diagram of an ISP pipeline, in accordance with various embodiments.

FIG. 3 is a block diagram of a latent diffusion model, in accordance with various embodiments.

FIG. 4 is a block diagram illustrating the training of a variational autoencoder (VAE) 400, in accordance with various embodiments.

FIG. 5 is a block diagram of an example latent projector, in accordance with various embodiments.

FIG. 6 is a block diagram of an exemplary latent deprojector architecture, in accordance with various embodiments.

FIG. 7 is a flowchart showing a method for hybrid image processing that integrates latent diffusion model outputs into an ISP pipeline, in accordance with various embodiments.

FIG. 8 is a block diagram of an example DNN system, in accordance with various embodiments.

FIG. 9 is a block diagram of an example computing device, in accordance with various embodiments.

### DETAILED DESCRIPTION

### Overview

Systems and methods are provided for a system-level architecture that enables real-time incorporation of AI-generated content into a camera's image processing pipeline while preserving the image quality benefits of traditional ISP processing. In particular, techniques are provided for merging latent diffusion model outputs with the ISP processing stream at arbitrary points within an ISP pipeline.

Latent diffusion models (LDMs) have emerged as a dominant paradigm for AI-based image generation and editing. In a latent diffusion model, a variational autoencoder (VAE) is first trained to compress images into a compact latent representation and to reconstruct images from that representation. A diffusion process then operates entirely within this reduced latent space, iteratively refining a noisy latent tensor into a coherent output conditioned on textual or other guidance signals. By operating in the latent space rather than at full pixel resolution, the diffusion process achieves substantial computational savings relative to pixel-space diffusion approaches. However, current approaches to AI-based image editing require the ISP to first produce a finished output image, after which a diffusion model processes that image offline. The sequential, post-hoc workflow introduces prohibitive latency and cannot support real-time use cases such as live video conferencing. Some approaches have explored replacing the ISP pipeline entirely with a diffusion model, but this approach is computationally expensive and ill-suited for hardware-constrained environments such as mobile devices and laptops. Other hybrid approaches have selectively integrated learned components into the ISP pipeline for tasks such as denoising or demosaicing.

In accordance with one or more embodiments, a hybrid image processing system is provided that integrates latent diffusion model outputs directly into a hardware image signal processing (ISP) pipeline through a set of floating latent space projection operators. Rather than treating AI-based content generation as a post-processing step applied to finished images, the disclosed system introduces novel hardware blocks that can be inserted at an arbitrary location within the ISP pipeline, enabling the merging of AI-generated content with the image data while the image data is still being processed. The system preserves the quality benefits of early-stage ISP processing and enables real-time operation by using the compact, semantically rich nature of the latent space.

According to various implementations, the system includes three principal hardware components that together form a tap-in, tap-out mechanism within the ISP pipeline. The first component is a latent projector, which is a compact convolutional neural network (CNN) that maps the ISP image data at a given pipeline stage into the latent space native to the diffusion model. The second component is a latent merge block, which combines the projected image representation with the output of the diffusion model within the latent space. The third component is a latent deprojector, which converts the merged latent representation back into the image domain so that subsequent ISP processing blocks can continue operating on the data. The three hardware components are collectively referred to as floating blocks because the hardware components can be placed between any two adjacent processing stages in the ISP pipeline. In various examples, the hardware components can be placed between block k and block k+1, where k can range from zero to the total number of blocks in the pipeline. In various examples, k is an integer in the range [0, N].

In some implementations, the tap-out point and the tap-in point do not coincide. For example, the latent projector may extract the image representation after a first pipeline block k₁, while the latent deprojector reinjects the merged result after a different pipeline block k₂, where k₁ and k₂ may differ. In some examples, an asymmetric tap configuration provides additional flexibility in accommodating the differing processing elements and data characteristics at various points in the ISP pipeline.

The placement of the floating blocks within the ISP pipeline can be guided by the nature of the selected content manipulation. For photorealistic content insertion (i.e., where the generated content should appear as though it were part of the original captured scene), the floating blocks are preferably placed at an early stage of the pipeline, such as in the raw domain prior to demosaicing. By placing the floating blocks at an early stage of the pipeline, subsequent ISP stages process the merged content in the same manner as the native image data, resulting in a more photorealistic output. For graphical overlays or synthetic content that need not undergo ISP processing, the floating blocks may be placed at a later stage, such as after sharpening or local contrast enhancement. For content that is photographic in nature but already of high quality, an intermediate placement, such as after color matching, may be appropriate.

According to various implementations, a technical consideration arising from the floating placement of the blocks is that the ISP pipeline exhibits domain heterogeneity across its stages. In particular, early-stage taps near the sensor operate in the raw Bayer domain, where the image data has four channels corresponding to the red, green-red, green-blue, and blue components of the Bayer color filter array, typically at high bit depth. Later-stage taps operate in the sRGB domain with three color channels and nonlinear gamma-corrected values. Accordingly, the latent projector and deprojector are not universal blocks but can be specifically instantiated and trained for each designated tap point to account for the channel count, color space characteristics, noise distributions, and bit-depth properties of the particular location in the pipeline.

In various implementations, the latent projector and deprojector are trained using knowledge distillation from the VAE encoder and decoder of the target latent diffusion model. In the knowledge distillation process, the compact projector network is trained to minimize a reconstruction loss between its output and the output of the full VAE encoder over a corpus of images representative of the target domain. In some examples, the training enables the small, hardware-efficient projector to approximate the behavior of the much larger VAE encoder. The same distillation approach can be applied to train the deprojector to approximate the VAE decoder. As an architectural optimization, the standard two-dimensional convolutions within the projector and deprojector may be replaced with separable convolutions following a depthwise-separable pattern (such as the pattern used in MobileNet architectures), substantially reducing the computational cost. Alternatively or additionally, end-to-end training may be employed, in which the projector, merge block, and deprojector are jointly optimized with respect to a task-specific loss function that penalizes, for example, border discontinuities, deviations from natural image statistics, and temporal inconsistencies across video frames.

In some implementations, the latent merge block supports multiple merging strategies of varying complexity. At its simplest, an alpha blending operation linearly combines the image latent and the diffusion latent using a fixed or per-channel blending coefficient. A more expressive approach concatenates the two latent tensors along the channel dimension and applies a learned convolutional filter to produce the merged output. For still greater expressiveness, a gated merging mechanism may be employed in which a learned gating function (e.g., a small CNN) produces a per-element blending mask conditioned on the diffusion output, the image latent, or both. At the highest complexity tier, a cross-attention mechanism may be used in which the image latent serves as the query and the diffusion latent provides the keys and values, allowing the merge to attend selectively to semantically relevant portions of the generated content.

To enable real-time operation, the system may employ a multi-tiered latency mitigation strategy. First, merging and projection computations are performed in the latent domain, which is typically reduced by a factor of approximately sixty-four in sample count relative to the raw image, yielding a commensurate reduction in computational load. Second, the diffusion model operates at a temporally subsampled rate (e.g., once every five frames), while the latent merge block persists or interpolates the most recent diffusion outputs across intervening frames. Because interpolation occurs in the latent space, interpolation produces semantically coherent transitions rather than pixel-level blending artifacts. Extrapolation may also be used in latency-sensitive scenarios where the subsequent diffusion output is not yet available. Third, in fixed-camera scenarios such as video conferencing, static background regions are identified and excluded from active diffusion processing through spatial masking, with cached diffusion outputs reused for those regions.

According to some implementations, the diffusion model is conditioned on user-provided textual prompts. In some examples, the conditioning on user-provided textual prompts can be achieved through a contrastive language-image pre-training (CLIP)-based text encoder, which transforms the prompt into high-dimensional embeddings that are semantically aligned with the visual latent space. The embeddings can be injected into the diffusion process via cross-attention layers, enabling the system to translate natural-language instructions (i.e., “illustrate the idea on the whiteboard as a professional diagram”) into pixel-level modifications of the captured video in real time.

In one illustrative example, the disclosed hybrid image processing system is used in a video conferencing scenario in which a portion of a frame depicting a whiteboard is augmented with generated graphical content that improves readability and comprehension. In such an example, a textual prompt may include, for instance, “add meaningful figures and/or diagrams to the context presented on the whiteboard,” and the floating blocks may be positioned at a late stage of the ISP pipeline (e.g., at or after a sharpening stage) such that the generated graphical content is incorporated without being subjected to earlier raw-domain processing operations that could degrade the appearance of overlays. In this manner, the diffusion model output can be merged into the processing stream in real time while maintaining a visually coherent output in the final frames.

The floating latent space projectors, the latent merging mechanism, and the associated training and latency mitigation techniques provide a comprehensive, hardware-accelerable framework for incorporating AI-generated content into a live camera pipeline. The system enables a new class of real-time, interactive camera experiences, such as augmenting whiteboard content in video conferences with AI-generated diagrams. In various examples, the system provides the images and videos at a level of visual fidelity and temporal coherence not achievable with existing approaches.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as implying that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Hybrid Image Processing System

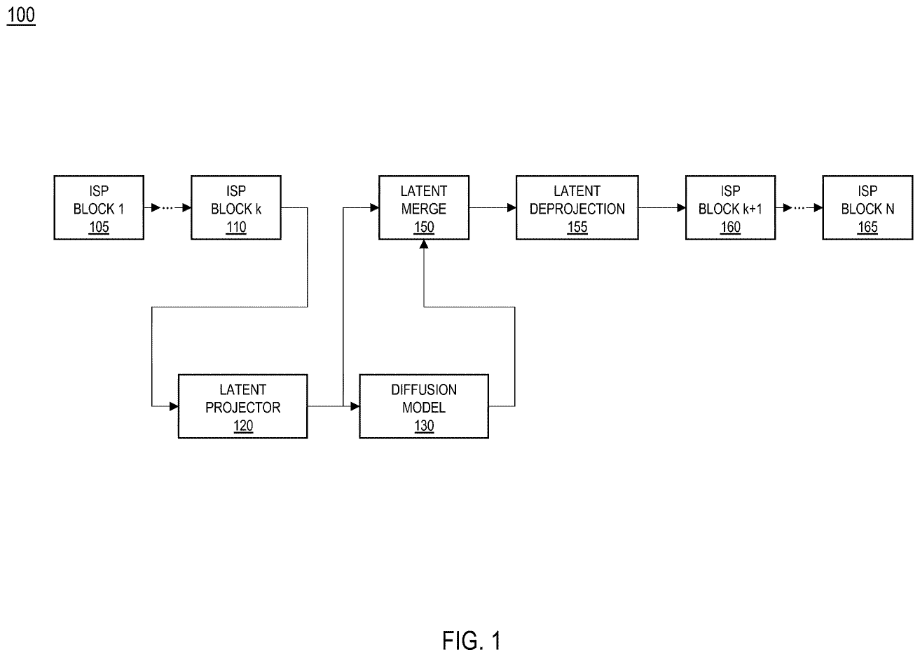

FIG. 1 is a block diagram of a hybrid image processing system 100 that integrates latent diffusion model outputs directly into a hardware image signal processing (ISP) pipeline, in accordance with various embodiments. The hybrid image processing system 100 includes a series of ISP processing blocks arranged sequentially, beginning with ISP block 1 105 and continuing through ISP block k 110, ISP block k+1 160, and up to ISP block N 165. Together, these ISP blocks form a pipeline that transforms raw sensor data into a viewable, high-quality image by performing operations such as lens shading correction, white balance, defective pixel correction, spatial denoising, demosaicing, color matching, tone mapping, temporal denoising, sharpening, and local contrast enhancement. In some examples, the output from ISP block N 165 is an output image from the ISP pipeline.

Between ISP block k 110 and ISP block k+1 160, the hybrid image processing system 100 includes three hardware blocks that form a tap-in, tap-out mechanism for interfacing with a diffusion model 130. A latent projector 120 receives the image data output by ISP block k 110 and maps the image data into the latent space native to the diffusion model 130. In some examples, the latent projector 120 is a compact convolutional neural network (CNN) that is trained, via knowledge distillation, to approximate the behavior of a variational autoencoder (VAE) encoder used by the diffusion model 130. The latent projector 120 converts the image space representation into a latent space representation. According to various examples, the latent space representation is much smaller and more semantically rich than the image data received by the latent projector 120.

The diffusion model 130 generates or modifies content in the latent space based on conditioning signals. The conditional signals may be textual prompts provided by a user. The output of the diffusion model 130 and the latent projection of the image data from the latent projector 120 are provided to a latent merge block 150. The latent merge block 150 combines the latent space representation of the image with the diffusion model's latent output to produce a merged latent representation. In some examples, the latent merge block 150 operates on the latent space tensors, allowing the original image information to be combined with the output of the diffusion model 130. The merging may be performed using various techniques, including, for example, alpha blending, convolutional blending, gated merging, or cross-attention. The technique or techniques used for the merging may depend on the use case and available computational resources.

In one example, for an alpha merging technique:

$${L}_{C} = ∝ {L}_{I} + ( 1 - ∝ ) {L}_{D} \qquad ( 1 )$$

where L_{C} is the combined latent representation, L_{I} is the image latent, and L_{D} is the diffusion latent, and ∝ is a fixed value. In some examples, ∝ can be different for each channel.

In one example, for a convolutional technique, the image latent and the diffusion latent can be combined with a shallow convolution layer:

$${L}_{C} = conv 2 {d}_{3 \times 3} [ \begin{matrix}{L}_{I} & {L}_{D}\end{matrix} ] \qquad ( 2 )$$

where the convolution is applied to a single concatenated latent (on the channel dimension). In various examples, equation (2) is a relatively inexpensive operation, at 4.5 MACS/pixel. In one example, for a gated merging technique:

$$g = σ ( f ( {L}_{D} ) ) \qquad ( 3 )$$

$${L}_{C} = g ⊙ {L}_{I} + ( 1 - g ) ⊙ {L}_{D} \qquad ( 4 )$$

where f( ) can be an arbitrary, trainable operator such as another small CNN.

In one example, for a cross-attention technique, the following equation can be used:

$${L}_{C} = Attn ( Q = {L}_{I} , ( K , V ) = {L}_{D} ) \qquad ( 5 )$$

The merged latent representation from the latent merge block 150 is provided to a latent deprojection block 155. The latent deprojection block 155 converts the merged latent representation (e.g., a tensor) back into the image domain. In some examples, the latent deprojection block 155 is trained, via knowledge distillation, to approximate the behavior of a VAE decoder of the diffusion model 130. The output of the latent deprojection block 155 is an image space representation that is provided to ISP block k+1 160, which continues processing the image data through the remaining stages of the ISP pipeline up to ISP block N 165.

According to various implementations, the value of k is an integer number and can take any value from 0 to N, where N is the number of processing blocks in the pipeline. That is, the latent projector 120, the latent merge block 150, and the latent deprojection block 155 may be placed between any two adjacent blocks in the ISP pipeline. The placement of the latent projector 120, the latent merge block 150, and the latent deprojection block 155 is selected based on the nature of the desired content manipulation. For example, placement of the latent projector 120, the latent merge block 150, and the latent deprojection block 155 at an early stage of the pipeline (e.g., in the raw domain prior to demosaicing) is suitable for photorealistic content insertion, where the generated content is to be processed by subsequent ISP blocks in the same manner as the native image data. Placement at a later stage (e.g., after sharpening or local contrast enhancement) is suitable for graphical overlays or synthetic content that need not undergo further ISP processing. According to various implementations, the latent projector 120 may tap out of the pipeline after a first block k₁ while the latent deprojection block 155 taps back in after a different block k₂, where k₁ can be different from k₂.

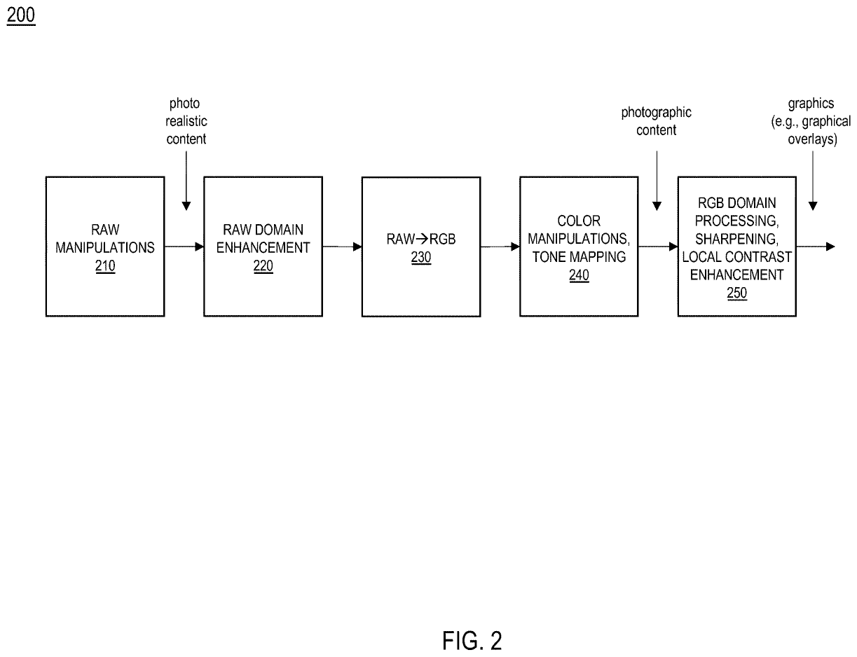

FIG. 2 is a block diagram of an ISP pipeline 200 illustrating the relationship between the placement of the floating hardware blocks and the type of content to be merged, in accordance with various embodiments. The ISP pipeline 200 includes a sequence of processing stages beginning with a raw manipulations block 210, which performs operations to undo sensor and lens issues such as linearity correction, white balance, lens shading correction, and defective pixel correction. The output of the raw manipulations block 210 is provided to a raw domain enhancement block 220, which performs spatial denoising on the raw image data. The output of raw domain enhancement block 220 is provided to a raw-to-RGB conversion block 230, which performs demosaicing to convert the single-channel Bayer mosaic data into a multi-channel color image. The output of raw-to-RGB block 230 is provided to a color manipulations and tone mapping block 240, which performs color matching and tone mapping to produce perceptually accurate color reproduction. The output of color manipulations and tone mapping block 240 is provided to an RGB domain processing, sharpening, local contrast enhancement block 250, which performs additional spatial and temporal denoising, sharpening, and local contrast enhancement to produce the final output image.

FIG. 2 further illustrates that the preferred placement of the floating hardware blocks within the ISP pipeline 200 depends on the nature of the content being merged. For photorealistic content that is intended to appear as though it were part of the original captured scene, the floating blocks are preferably placed at an early stage of the pipeline, such as before or within raw manipulations block 210 or raw domain enhancement block 220, so that the merged content is subsequently processed by the full chain of ISP stages in the same manner as the native sensor data. For photographic content that is already of high quality and does not require the full ISP processing chain, the floating blocks may be placed at an intermediate stage, such as after color manipulations and tone mapping block 240. For graphics content such as graphical overlays, the floating blocks are preferably placed at a late stage of the pipeline, such as at or after RGB domain processing, sharpening, local contrast enhancement block 250, so that the synthetic content is not subjected to ISP processing operations that could degrade its appearance.

A further consideration in selecting the placement of the floating blocks is the availability of training data. Training data for stages later in the pipeline (e.g., after raw-to-RGB block 230) is widely available, as it includes standard color images that can be obtained from public sources. Training data for earlier stages of the pipeline (e.g., within raw manipulations block 210 or raw domain enhancement block 220) is sensor-dependent and not widely available in the public domain, which may increase the difficulty of training the latent projector and latent deprojection block for early-stage placements.

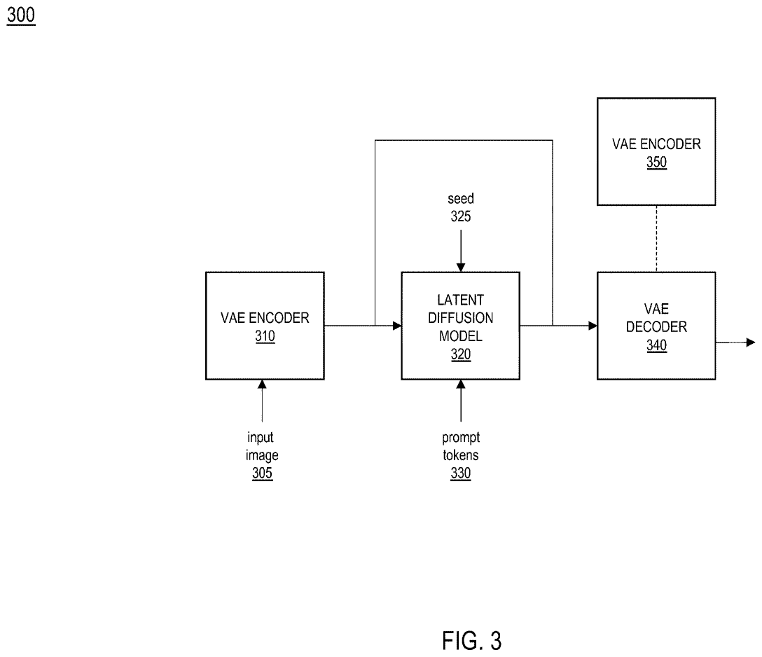

FIG. 3 is a block diagram of a canonical latent diffusion model 300, in accordance with various embodiments. The latent diffusion model 300 operates by first encoding an input image 305 through a VAE encoder 310, which compresses the input image 305 into a compact latent representation. The latent representation produced by the VAE encoder 310 captures a semantically rich, reduced-dimensionality version of the input image 305. Typically, the image is reduced at a ratio of approximately 8× on each spatial axis, resulting in a total sample count that is approximately 64× smaller than the full image.

The latent representation of the input image, together with a seed 325 and prompt tokens 330, is provided to a latent diffusion model 320. The seed 325 provides an initial noise signal. The prompt tokens 330 can be derived from a user-provided textual prompt processed through a text encoder such as a contrastive language-image pre-training (CLIP)-based encoder. The prompt tokens 330 are injected into the diffusion process via cross-attention layers. In some examples, the injection of the prompt tokens 330 enables the latent diffusion model 320 to condition its output on the semantic content of the user's instructions. The latent diffusion model 320 iteratively refines the latent representation through a diffusion process to generate a modified latent output that reflects the requested content generation or manipulation.

The modified latent output of the latent diffusion model 320 is provided to a VAE decoder 340, which reconstructs a full-resolution image from the latent representation. The VAE encoder 310, VAE encoder 350, and VAE decoder 340 are trained jointly so that the compressed latent representation retains sufficient information for the VAE decoder 340 to reconstruct an image that closely approximates the original input. In some examples, the VAE encoder 310 and VAE decoder 340 can learn a compact, semantically meaningful representation in which manipulating individual latent elements can produce coherent, high-level changes in the decoded image, such as modifying object attributes or scene characteristics. In various examples, the VAE encoder-decoder are trained together such that: decode (encode(X))~X. In some examples, in a latent diffusion model inference framework, only the VAE decoder 340 is used, basically reusing the knowledge of the VAE encoder to work in a compressed space and then decode the input. However, the VAE encoder is a part of the training of the VAE decoder. For example, the VAE encoder can define the loss function. In some examples, the VAE encoder 350 can be used to knowledge-distill the latent projector.

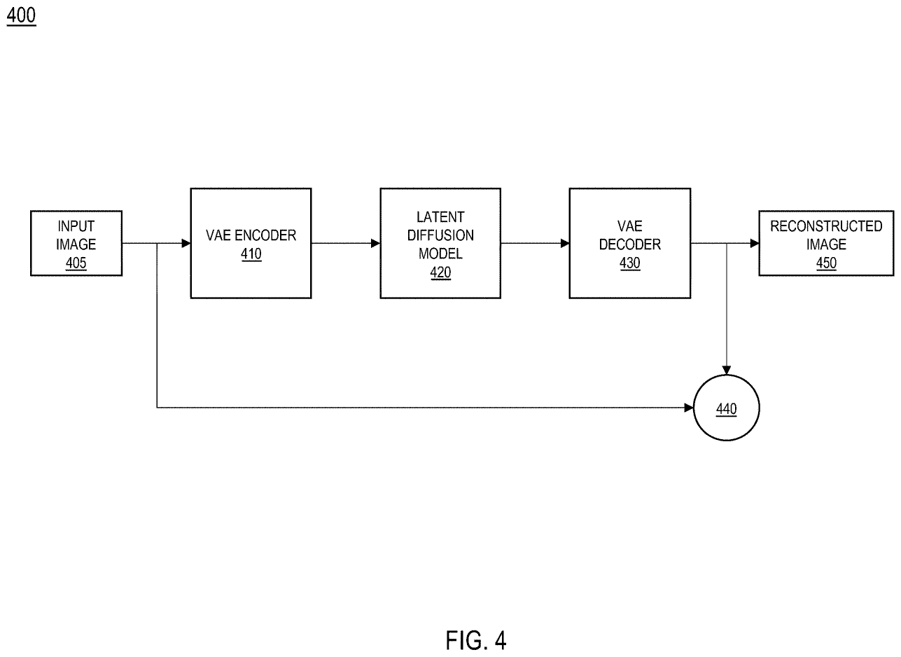

FIG. 4 is a block diagram illustrating the training of a variational autoencoder (VAE) 400, in accordance with various embodiments. An input image 405 is provided to a VAE encoder 410, which compresses the input image 405 into a compact latent representation. The VAE encoder 410 is a deep neural network that gradually reduces the spatial resolution of the image while learning a semantically rich, reduced-dimensionality representation. The compact latent representation produced by the VAE encoder 410 captures high-level semantic features of the input image 405, such that manipulating individual elements of the latent representation can produce coherent, high-level changes in a subsequently decoded image.

The latent representation is provided to a latent diffusion model 420, which operates entirely within the latent space to generate or modify content based on conditioning signals such as textual prompts. The output of the latent diffusion model 420 is provided to a VAE decoder 430, which reconstructs a full-resolution image from the latent representation. The VAE decoder 430 mirrors the encoder by gradually increasing the spatial resolution while reducing the channel depth to produce a reconstructed image 450 that approximates the input image 405.

The reconstructed image 450 and the input image 405 are both provided to a reconstruction loss block 440, which computes a loss value representing the difference between the two images. The reconstruction loss block 440 may determine, for example, the absolute difference between the input image 405 and the reconstructed image 450. During training, the parameters of the VAE encoder 410 and the VAE decoder 430 are jointly optimized to minimize the loss determined by the reconstruction loss block 440 over a large corpus of images. The training process drives the VAE encoder 410 to learn the most compact representation possible that still allows the VAE decoder 430 to faithfully reconstruct the input image 405, resulting in a latent space that is both highly compressed and semantically meaningful.

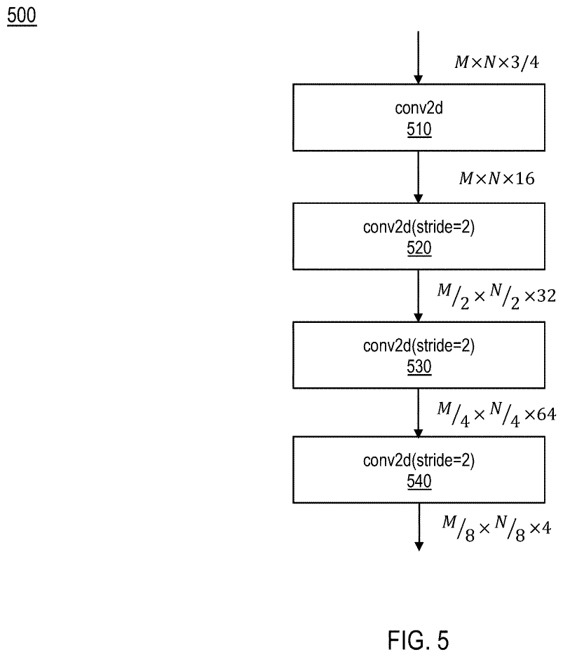

FIG. 5 is a block diagram of an example latent projector 500, in accordance with various embodiments. The latent projector 500 is a compact convolutional neural network (CNN) configured in an encoder arrangement that maps an image from the image domain into the latent space of a diffusion model. The latent projector 500 is a knowledge-distilled version of the VAE encoder and is trained to approximate the behavior of the full VAE encoder while being sufficiently compact for hardware implementation within the ISP pipeline. In some examples, the latent projector 500 can be a function of Pe such that:

$${argmin}_{θ} ( ℒ ( E ( I ) , {P}_{θ} ( I ) ) ) \qquad ( 6 )$$

Where [symbol] is a reconstruction loss over a set of natural images. As shown in the example latent projector 500, a few stages of 2D convolution gradually reduce the resolution of the image and inflate the channel count to generate a richer representation. The channel count is then collapsed to compress the representation.

The latent projector 500 receives an input having spatial dimensions M×N and a channel depth of 3 or 4, depending on where in the ISP pipeline the latent projector is placed. When operating in the raw Bayer domain (i.e., before demosaicing), the input has 4 channels corresponding to the red, green-red, green-blue, and blue components of the Bayer color filter array. When operating in the sRGB domain (i.e., after demosaicing), the input has 3 channels corresponding to the red, green, and blue color channels.

In various implementations, early-stage image data in the raw domain may be represented at high bit depth, for example, in a range of approximately 10-16 bits per sample, and in some cases at higher effective bit depth for high dynamic range (HDR) image signals. In such implementations, the latent projector may be instantiated and/or trained to account for the bit-depth characteristics of the selected tap point, such that projection preserves salient information present in the higher-precision representation while producing an image-space representation suitable for subsequent processing blocks of the ISP pipeline.

The input is provided to a conv2d block 510, which applies a two-dimensional convolution that increases the channel depth from 3 or 4 to 16 while maintaining the spatial dimensions at M×N. The output of conv2d block 510 is provided to a conv2d (stride=2) block 520, which applies a strided two-dimensional convolution that reduces the spatial dimensions by a factor of 2 to M/2×N/2 while increasing the channel depth to 32. The output of conv2d (stride=2) block 520 is provided to a conv2d (stride=2) block 530, which further reduces the spatial dimensions by a factor of 2 to M/4×N/4 while increasing the channel depth to 64. The output of conv2d (stride=2) block 530 is provided to a conv2d (stride=2) block 540, which reduces the spatial dimensions by another factor of 2 to M/8×N/8 while collapsing the channel depth to 4. The output of conv2d (stride=2) block 540 is the latent space representation, having dimensions M/8×N/8×4, which corresponds to the compact latent representation used by the diffusion model.

The series of strided convolutions in the latent projector 500 gradually reduces the spatial resolution while inflating the channel count to develop a progressively richer representation of the image, before ultimately compressing the channel count to produce the final compact latent. In some examples, the architecture has approximately 25,000 parameters and utilizes approximately 2,700 multiply-accumulate operations (MACs) per input pixel. In various examples, any operator capable of effectively reducing the image to the latent space may be used. As one example optimization, the standard conv2d operations may be replaced with a separable convolution chain of conv1d (depthwise conv2d (conv1d( ))), following the depthwise-separable pattern used in MobileNet architectures, which can substantially reduce computational cost.

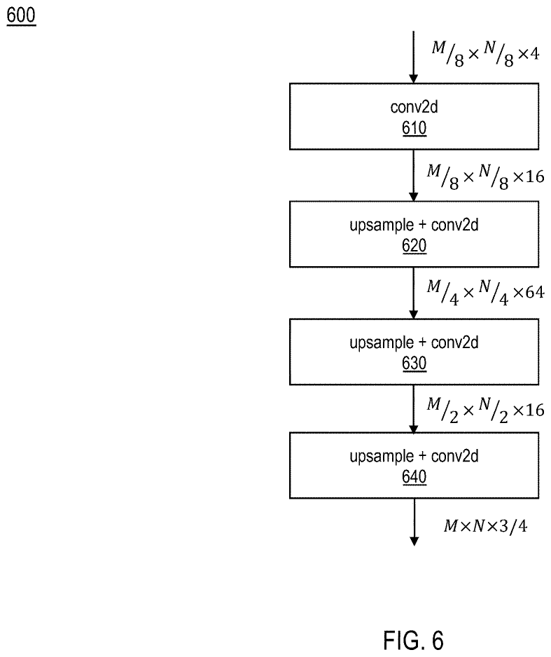

FIG. 6 is a block diagram of an exemplary latent deprojector architecture 600, in accordance with various embodiments. The latent deprojector 600 is a compact convolutional neural network (CNN) configured in a decoder arrangement that maps a latent space representation back into the image domain. In some examples, the latent deprojector 600 is a knowledge-distilled version of the VAE decoder and is trained to approximate the behavior of the full VAE decoder while being sufficiently compact for hardware implementation within the ISP pipeline.

According to various implementations, the latent deprojector 600 receives an input having dimensions M/8×N/8×4, corresponding to the compact latent space representation. The input is first provided to a conv2d block 610, which applies a two-dimensional convolution that increases the channel depth from 4 to 16 while maintaining the spatial dimensions at M/8×N/8. The output of conv2d block 610 is provided to an upsample+conv2d block 620, which applies a bilinear upsampling operation followed by a two-dimensional convolution to increase the spatial dimensions by a factor of 2 to M/4×N/4 while increasing the channel depth to 64. The output of upsample+conv2d block 620 is provided to an upsample+conv2d block 630, which further increases the spatial dimensions by a factor of 2 to M/2×N/2 while reducing the channel depth to 16. The output of upsample+conv2d block 630 is provided to an upsample+conv2d block 640, which increases the spatial dimensions by another factor of 2 to M×N while reducing the channel depth to 3 or 4. The output of upsample+conv2d block 640 is the reconstructed image space representation, having dimensions M×N×3 for sRGB domain output or M×N×4 for raw Bayer domain output.

In various implementations, early-stage image data in the raw domain may be represented at high bit depth, for example, in a range of approximately 10-16 bits per sample, and in some cases at higher effective bit depth for high dynamic range (HDR) image signals. In such implementations, the latent deprojector may be instantiated and/or trained to account for the bit-depth characteristics of the selected tap point, such that deprojection preserves salient information present in the higher-precision representation while producing an image-space representation suitable for subsequent processing blocks of the ISP pipeline.

In various examples, the series of upsampling and convolution stages in the latent deprojector 600 progressively restores the spatial resolution of the latent representation while adjusting the channel depth to match the image domain at the target tap-in point in the ISP pipeline. The complexity of the latent deprojector 600 may vary depending on where in the ISP pipeline it is placed. At later stages of the pipeline, a more complex deprojector with greater fidelity may be used because fewer subsequent ISP processing blocks remain to correct any artifacts introduced during deprojection. At earlier stages, a simpler and computationally cheaper deprojector may suffice because the remaining ISP processing blocks will further refine the image.

### Example Training of a Hybrid Image Processing System

The latent projector, the latent merge block, and the latent deprojector each comprise trainable parameters whose values must be determined before deployment. Several training approaches are possible, including knowledge distillation and end-to-end training, each of which may be used independently or in combination.

Knowledge distillation (KD), also referred to as teacher-student learning, is the practice of training a smaller student model to imitate the behavior of a larger, pre-trained teacher model. Let FS denote the student function, Fr denote the teacher function, θ denote the student function parameter set, and C denote the corpus of training data. Knowledge distillation can be defined as:

$${argmin}_{θ} ℒ ( {F}_{T} ( d ) , {F}_{S} ( d , θ ) ) \qquad ( 7 )$$

Where d∈C, and [symbol] can represent any of many possible similarity losses, such as [symbol] loss and Kullback-Leibler divergence loss.

Using this knowledge distillation framework, the latent projector is trained to behave like the VAE encoder of the diffusion model, and the latent deprojector is trained to behave like the VAE decoder of the diffusion model. Specifically, for the latent projector, the teacher function F_{T} is the VAE encoder E, the student function F_{S} is the latent projector P_{θ}, and the training objective is:

$${argmin}_{θ} ( ℒ ( E ( I ) , {P}_{θ} ( I ) ) ) \qquad ( 8 )$$

where [symbol] is a reconstruction loss, such as the absolute difference, computed over a set of natural images I. The latent projector is thereby trained to produce latent representations that closely approximate those produced by the full VAE encoder, despite having a much smaller and more hardware-efficient architecture. The same distillation approach can be applied symmetrically to train the latent deprojector to approximate the VAE decoder. In various examples, knowledge distillation provides the most direct path to obtaining a working prototype or production deployment, as it leverages the pre-trained VAE components as supervision without a task-specific loss function.

In various examples, the weights of the latent projector and the latent deprojector can differ depending on where in the ISP pipeline the floating blocks are placed. Because the ISP pipeline exhibits domain heterogeneity across its stages (e.g., differences in channel count, color space characteristics, noise distributions, and bit depth), the latent projector and latent deprojector are specifically instantiated and retrained via knowledge distillation for each designated tap point to account for the unique properties of that location in the pipeline.

According to various implementations, another training approach is end-to-end training. In some implementations, one or more operations within an ISP pipeline may be non-differentiable and/or may not be expressed in a form suitable for direct gradient-based optimization. Accordingly, during end-to-end training, the ISP portion of the processing chain may be approximated for purposes of optimization, for example, by using one or more differentiable approximations and/or surrogate models that approximate the behavior of one or more ISP blocks, while the task-specific loss is evaluated on an image-domain output of the overall system. In this manner, parameters of the latent projector, latent merge block, and latent deprojector may be jointly optimized with respect to the task-specific loss despite the presence of non-differentiable ISP operations in the overall processing path.

In end-to-end training, the latent projector, the latent merge block, and the latent deprojector may be jointly trained end-to-end on a target task. In end-to-end training, a task-specific loss function [symbol] is defined that operates in the image domain on the final output of the system. The latent projector can be F_{P}(I, θ_{P}) with parameters θ_{P}. The latent merge block can be F_{M}(L_{D}, L_{I}, θ_{M}) with parameters θ_{M}. The latent deprojector can be F_{D}(L, θ_{D}) with parameters θ_{D}. The ISP function up to block k can be

$${F}_{I}^{pre} ( I ) .$$

The ISP function from block k+1 to block N can be

$${F}_{I}^{post} ( I ) .$$

Given a diffusion model result L_{D}, the end-to-end model is:

$$F ( I , {θ}_{P} , {θ}_{D} , {θ}_{M} ) = {F}_{I}^{post} ( {F}_{D} ( {F}_{M} ( {L}_{D} , {F}_{P} ( {F}_{I}^{pre} ( I ) , {θ}_{P} ) , {θ}_{M} ) , {θ}_{D} ) ) \qquad ( 9 )$$

The learning objective can become:

$${argmin}_{{θ}_{P} , {θ}_{D} , {θ}_{M}} {ℒ}_{E} ( F ( I , {θ}_{P} , {θ}_{D} , {θ}_{M} ) ) \qquad ( 10 )$$

### Where I∈C.

The task-specific loss function [symbol] may incorporate multiple cost elements depending on the desired behavior of the system. For example, if the objective is to inject a diffusion-model-generated object into the image such that the injection appears natural, the loss function may include cost elements for border discontinuities (e.g., computed by calculating derivatives only around the borders of injected objects), natural image properties (e.g., penalizing deviations in color and noise characteristics from the surrounding native image content), and temporal consistency (e.g., penalizing differences between latent representations of consecutive frames). The formulation and weighting of these cost elements may be application-dependent.

In various examples, the diffusion model may be operated at a reduced temporal rate relative to the ISP pipeline. For example, the diffusion model may generate a new diffusion latent output once every N frames (e.g., N=5). For frames in which the diffusion model does not generate a new output, a temporal interpolation between available diffusion latent outputs may be performed. Specifically, the interpolated diffusion latent L_{D}(t) at time t may be computed as:

$${L}_{D} ( t ) = {L}_{D} ( {t}_{0} ) + \frac{t - {t}_{0}}{{t}_{1} - {t}_{0}} ( {L}_{D} ( {t}_{1} ) - {L}_{D} ( {t}_{0} ) ) \qquad ( 11 )$$

where t₀ and t₁ are the times of the two nearest available diffusion latent outputs. In latency-sensitive cases where the subsequent diffusion latent output L_{D}(t₁) is not yet available, extrapolation from previous outputs may be used instead. Because this interpolation is performed in the latent space rather than in the image space, it produces semantically coherent transitions rather than pixel-level blending artifacts such as ghosting or double images.

Further temporal optimization may be achieved by incorporating temporal consistency into the end-to-end loss function described above, thereby implicitly training the latent merge block to act as a temporal smoothing function. Additionally, the latent merge block may be configured to identify static regions within the image and to bypass active merging for those regions, instead reusing cached diffusion latent outputs. This spatial masking restricts the diffusion processing to localized, dynamic regions of interest, further reducing the computational overhead required for real-time operation.

### Example Latency Mitigation Techniques

To ensure real-time plausibility within a hardware-constrained ISP environment, the hybrid image processing system can employ a three-tiered optimization strategy to overcome the iterative bottleneck of the diffusion process. The first tier is latent-domain computation. Unlike traditional image-to-image models that operate on full-resolution pixel grids, the iterative diffusion process in the disclosed system occurs exclusively on the low-resolution compressed features provided by the latent projector. By operating in a reduced domain (e.g., approximately 64× fewer samples than the raw input and approximately 48× fewer samples for sRGB domain input), the computational load per iteration is reduced by orders of magnitude relative to full-resolution processing.

The second tier is temporal sub-sampling. Given that semantic content in a video stream often exhibits high temporal redundancy, the diffusion model is designed to operate at a lower frequency than the primary ISP pipeline. For example, the diffusion model may trigger once every N frames, where N is typically 5. The latent merge block persists the most recent AI-generated features across subsequent frames or utilizes latent-space interpolation, as described above, to ensure a smooth visual transition without a full diffusion iteration for every single frame. Extrapolation may also be used in latency-sensitive cases where the next diffusion output is not yet available.

The third tier is static background masking. In scenarios with fixed camera positions, such as video conferencing, compute is further optimized via spatial masking. The system identifies static background regions and restricts the iterative diffusion process to localized, dynamic regions of interest (ROIs). Pixels belonging to the static background utilize cached diffusion outputs, drastically reducing the total number of patches that require active synthesis and merging. Together, these three tiers of optimization enable the hybrid image processing system to incorporate AI-generated content into a live video stream in real time while operating within the power, compute, and latency constraints of hardware-accelerated ISP environments.

Together, the latent-domain computation (which reduces the sample count by approximately 64× relative to the raw image), the temporal subsampling of the diffusion model, and the static background masking form a three-tiered latency mitigation strategy that enables the hybrid image processing system to operate in real time within a hardware-constrained ISP environment.

### Example Method for Hybrid Image Processing

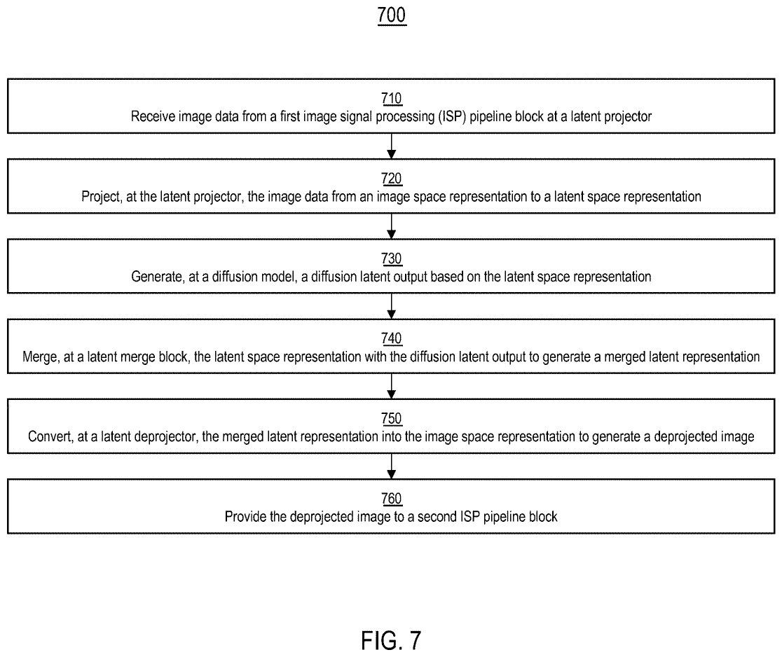

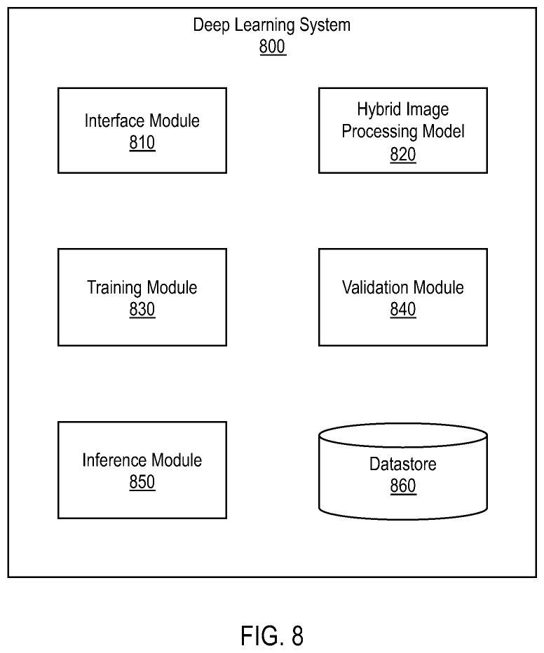

FIG. 7 is a flowchart showing a method 700 for hybrid image processing that integrates latent diffusion model outputs into a hardware image signal processing (ISP) pipeline, in accordance with various embodiments. In some examples, the method 700 may be used for video processing, including for real-time video conferencing. The method 700 may be performed by the systems of FIGS. 1-4, and/or by the deep learning system 800 in FIG. 8. Although the method 700 is described with reference to the flowchart illustrated in FIG. 7, other methods may alternatively be used. For example, the order of execution of the steps in FIG. 7 may be changed. As another example, some of the steps may be changed, eliminated, or combined.

At 710, image data is received from a first image signal processing (ISP) pipeline block at a latent projector. The first ISP pipeline block may be any of the sequential processing blocks within the ISP pipeline, such as a raw manipulations block, a raw domain enhancement block, a demosaicing block, a color manipulations and tone mapping block, or an RGB domain processing, sharpening, and local contrast enhancement block. The selection of which ISP pipeline block serves as the first block depends on the nature of the content manipulation to be performed. For photorealistic content insertion, the first block may be an early-stage block, such as a raw manipulations block, so that the merged content is subsequently processed by the remaining ISP stages. For graphical overlays or synthetic content, the first block may be a later-stage block. The image data received at the latent projector has a channel depth that depends on the position of the first block within the pipeline: four channels when operating in the raw Bayer domain prior to demosaicing, corresponding to the red, green-red, green-blue, and blue components of the Bayer color filter array, or three channels when operating in the sRGB domain after demosaicing.

At 720, the latent projector projects the image data from an image space representation to a latent space representation. The latent space representation corresponds to the latent space of a diffusion model and is a compact, semantically rich encoding of the image data. The latent projector may be implemented as a compact convolutional neural network (CNN) including a series of two-dimensional convolutions that gradually reduce the spatial resolution of the image while increasing and then collapsing the channel depth to produce the latent representation. The latent projector may be trained via knowledge distillation to approximate the behavior of the variational autoencoder (VAE) encoder of the diffusion model. In some examples, the standard two-dimensional convolutions within the latent projector may be replaced with separable convolutions following a depthwise-separable pattern, which can reduce computational cost.

At 730, a diffusion model generates a diffusion latent output based on the latent space representation. The diffusion model operates entirely within the latent space and may be conditioned on one or more conditioning signals, such as textual prompts provided by a user. The textual prompts may be processed through a text encoder, such as a contrastive language-image pre-training (CLIP)-based encoder, to produce high-dimensional embeddings that are semantically aligned with the visual latent space. These embeddings may be injected into the diffusion process via cross-attention layers, enabling the diffusion model to translate natural-language instructions into modifications of the latent representation. The diffusion model may operate at a temporally subsampled rate relative to the ISP pipeline, for example, once every N frames, with the most recent diffusion latent output persisted or interpolated across intervening frames. In latency-sensitive cases, extrapolation from a previous diffusion latent output may be used when a subsequent output is not yet available. In fixed-camera scenarios, static background regions may be identified and excluded from active diffusion processing through spatial masking, with cached diffusion outputs reused for those regions.

At 740, a latent merge block merges the latent space representation of the image data with the diffusion latent output to generate a merged latent representation. According to various examples, there are multiple techniques that may be used to perform the merging. In some examples, the merging includes an alpha blending operation that linearly combines the image latent and the diffusion latent using a fixed or per-channel blending coefficient. In some examples, the image latent and the diffusion latent are concatenated along a channel dimension and a learned convolutional filter is applied to generate the merged latent representation. In some examples, a gated merging mechanism is used in which a learned gating function, such as a small CNN, generates a per-element blending mask conditioned on the diffusion latent, the image latent, or both. In some examples, a cross-attention mechanism is used in which the image latent serves as a query and the diffusion latent provides keys and values, enabling the merge to attend selectively to semantically relevant portions of the generated content. The latent merge block may additionally be configured to identify static regions of the image and bypass merging for those regions, thereby reducing computational overhead.

At 750, a latent deprojector converts the merged latent representation into the image space representation to generate a deprojected image. The latent deprojector may be implemented as a compact CNN comprising a series of upsampling and two-dimensional convolution stages that progressively restore the spatial resolution of the latent representation while adjusting the channel depth to match the image domain at the target location in the ISP pipeline. The latent deprojector may be trained via knowledge distillation to approximate the behavior of the VAE decoder of the diffusion model. The output of the latent deprojector has a channel depth of three for sRGB domain output or four for raw Bayer domain output, corresponding to the position at which the deprojected image is reinjected into the ISP pipeline. The complexity of the latent deprojector may vary depending on its placement: a more complex deprojector may be used at later stages of the pipeline where fewer subsequent ISP processing blocks remain to correct artifacts, while a simpler deprojector may suffice at earlier stages.

At 760, the deprojected image is provided to a second ISP pipeline block for continued processing through one or more remaining processing blocks of the ISP pipeline. The second ISP pipeline block may be the block immediately following the first ISP pipeline block from which the image data was received at 710. Alternatively, in a more general configuration, the second ISP pipeline block may be a different block than the one immediately following the first block, such that the latent projector taps out of the pipeline after a first block k₁ and the latent deprojector taps back in after a different block k₂, where k₁ can be different from k₂. The remaining ISP processing blocks continue to process the deprojected image in the same manner as native image data, applying operations such as denoising, color matching, tone mapping, sharpening, and local contrast enhancement as appropriate given the position of the second ISP pipeline block within the pipeline.

### Example DNN System for Hybrid Image Processing

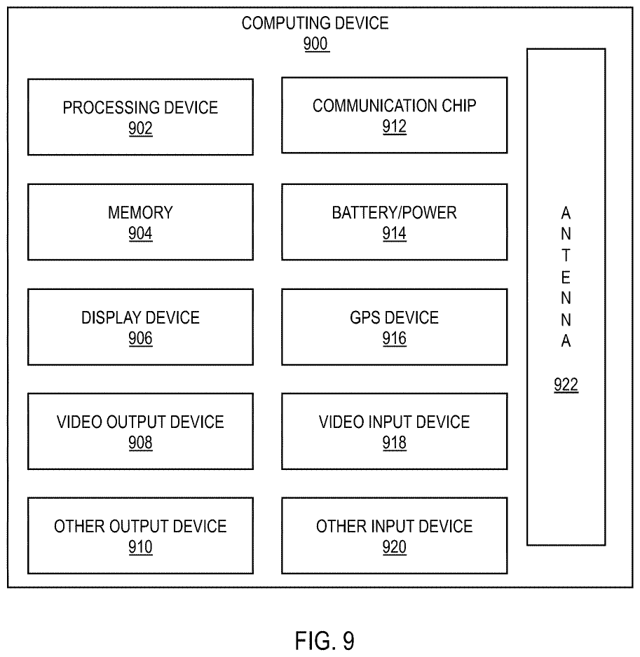

FIG. 8 is a block diagram of an example deep learning system 800, in accordance with various embodiments. The deep learning system 800 trains deep neural networks for various tasks, including hybrid image processing using a diffusion model. The deep learning system 800 includes an interface module 810, a hybrid image processing model 820, a training module 830, a validation module 840, an inference module 850, and a datastore 860. In other embodiments, alternative configurations, different or additional components may be included in the deep learning system 800. Further, functionality attributed to a component of the deep learning system 800 may be accomplished by a different component included in the deep learning system 800 or a different system. The deep learning system 800 or a component of the deep learning system 800 (e.g., the training module 830 or inference module 850) may include the computing device 900 in FIG. 9.

The interface module 810 facilitates communication of the deep learning system 800 with other systems. As an example, the interface module 810 supports the deep learning system 800 to distribute trained deep neural networks to other systems, e.g., computing devices configured to apply deep neural networks to perform tasks. As another example, the interface module 810 establishes communication between the deep learning system 800 and an external database to receive data that can be used to train deep neural networks or input into deep neural networks to perform tasks. In some embodiments, data received by the interface module 810 may have a data structure, such as a matrix. In some embodiments, data received by the interface module 810 may be an image, a series of images, and/or a video stream.

The hybrid image processing model 820 includes one or more trainable components of the hybrid image processing system, including the latent projector, the latent merge block, and the latent deprojector, as well as a diffusion model. In some examples, the hybrid image processing model 820 performs hybrid image processing on input videos by projecting image data into the latent space of the diffusion model, merging the diffusion model output with the projected image data, and deprojecting the merged result back into the image domain. In general, the hybrid image processing model 820 includes an image signal processing (ISP) pipeline and a diffusion model. The hybrid image processing model 820 receives video data and generates output video in which AI-generated or AI-modified content has been incorporated into the original video frames. During training, the hybrid image processing model 820 can use ground-truth images, knowledge distillation targets from the VAE encoder and VAE decoder of the diffusion model, and/or task-specific loss functions as described herein.

The training module 830 trains deep neural networks by using training datasets. In some embodiments, a training dataset for training a deep neural network may include one or more images and/or videos, each of which may be a training sample. In some examples, the training module 830 trains the hybrid image processing model 820. The training module 830 may receive real-world image data for processing with the hybrid image processing model 820 as described herein. In some embodiments, the training module 830 trains the latent projector and the latent deprojector via knowledge distillation using the VAE encoder and VAE decoder of the diffusion model as teacher models, respectively. In some embodiments, the training module 830 trains the latent projector, the latent merge block, and the latent deprojector jointly via end-to-end training using a task-specific loss function that penalizes border discontinuities, deviations from natural image properties, and temporal inconsistencies. In some embodiments, the training module 830 may input different data into different layers of the deep neural network. For every subsequent deep neural network layer, the input data may be less than the previous deep neural network layer. In some examples, the hybrid image processing model 820 can be trained with ground-truth processed images. In some examples, the difference between the hybrid image processing model 820 image output and the corresponding ground-truth image can be measured as the number of pixels in the corresponding maps that have different classifications from each other.

In some embodiments, a part of the training dataset may be used to initially train the deep neural network, and the rest of the training dataset may be held back as a validation subset used by the validation module 840 to validate the performance of a trained deep neural network. The portion of the training dataset not including the tuning subset and the validation subset may be used to train the deep neural network.

The training module 830 also determines hyperparameters for training the deep neural network. Hyperparameters are variables specifying the deep neural network training process. Hyperparameters are different from parameters inside the deep neural network (e.g., weights of filters). In some embodiments, hyperparameters include variables determining the architecture of the deep neural network, such as the number of hidden layers, etc. Hyperparameters also include variables that determine how the deep neural network is trained, such as batch size, number of epochs, etc. A batch size defines the number of training samples to work through before updating the parameters of the deep neural network. The batch size is the same as or smaller than the number of samples in the training dataset. The training dataset can be divided into one or more batches. The number of epochs defines how many times the entire training dataset is passed forward and backward through the entire network. The number of epochs defines the number of times that the deep learning algorithm works through the entire training dataset. One epoch means that each training sample in the training dataset has had an opportunity to update the parameters inside the deep neural network. An epoch may include one or more batches. The number of epochs may be 1, 10, 50, 100, or even larger.

The training module 830 defines the architecture of the deep neural network, e.g., based on some of the hyperparameters. The architecture of the deep neural network includes an input layer, an output layer, and a plurality of hidden layers. The input layer of a deep neural network may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the deep neural network abstract the input image to a feature map that is represented by a tensor specifying the feature map height, the feature map width, and the feature map channels (e.g., red, green, blue images include three channels). A pooling layer is used to reduce the spatial volume of the input image after convolution. It is used between two convolutional layers. A fully connected layer involves weights, biases, and neurons. It connects neurons in one layer to neurons in another layer. It is used to classify images between different categories by training.

In the process of defining the architecture of the deep neural network, the training module 830 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 830 defines the architecture of the deep neural network, the training module 830 inputs a training dataset into the deep neural network. The training dataset includes a plurality of training samples. An example of a training dataset includes a series of images of a video stream. In some embodiments, real-world video frames are input to the hybrid image processing model 820 and processed through the latent projector, latent merge block, and latent deprojector to produce model-generated output images. In the backward pass, the training module 830 modifies the internal parameters of the deep neural network to minimize a loss function computed between the model-generated output and corresponding target outputs, such as knowledge distillation targets from the VAE encoder and VAE decoder or ground-truth images for end-to-end training. The internal parameters include weights of filters in the convolutional layers of the deep neural network. In some embodiments, the training module 830 uses a cost function to minimize the differences.

The training module 830 may train the deep neural network for a predetermined number of epochs. The number of epochs is a hyperparameter that defines the number of times that the deep learning algorithm will work through the entire training dataset. One epoch means that each sample in the training dataset has had an opportunity to update internal parameters of the deep neural network. After the training module 830 finishes the predetermined number of epochs, the training module 830 may stop updating the parameters in the deep neural network. The deep neural network having the updated parameters is referred to as a trained deep neural network.

The validation module 840 verifies the accuracy of trained deep neural networks. In some embodiments, the validation module 840 inputs samples in a validation dataset into a trained deep neural network and uses the outputs of the deep neural network to determine the model accuracy. In some embodiments, a validation dataset may be formed of some or all the samples in the training dataset. Additionally or alternatively, the validation dataset includes additional samples, other than those in the training sets. In some embodiments, the validation module 840 may determine an accuracy score measuring the precision, recall, or a combination of precision and recall of the deep neural network. The validation module 840 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 840 may compare the accuracy score with a threshold score. In an example where the validation module 840 determines that the accuracy score of the hybrid image processing model 820 is lower than the threshold score, the validation module 840 instructs the training module 830 to re-train the deep neural network. In one embodiment, the training module 830 may iteratively re-train the deep neural network until the occurrence of a stopping condition, such as the accuracy measurement indicating that the deep neural network may be sufficiently accurate, or a number of training rounds having taken place.

The inference module 850 applies the trained or validated deep neural network to perform tasks. The inference module 850 may run inference processes of a trained or validated deep neural network. In some examples, inference makes use of the forward pass to produce model-generated output for unlabeled real-world data. For instance, the inference module 850 may input real-world video data into the deep neural network and receive an output of the deep neural network. The output of the deep neural network may include output video frames in which AI-generated or AI-modified content has been merged with the original image data by the latent projector, latent merge block, and latent deprojector operating within the ISP pipeline.

The inference module 850 may aggregate the outputs of the deep neural network to generate a final result of the inference process. In some embodiments, the inference module 850 may distribute the deep neural network to other systems, e.g., computing devices in communication with the deep learning system 800, for the other systems to apply the deep neural network to perform the tasks. The distribution of the deep neural network may be done through the interface module 810. In some embodiments, the deep learning system 800 may be implemented in a server, such as a cloud server, an edge server, and so on. The computing devices may be connected to the deep learning system 800 through a network. Examples of the computing devices include edge devices.

The datastore 860 stores data received, generated, used, or otherwise associated with the deep learning system 800. For example, the datastore 860 stores video processed by the hybrid image processing model 820 or used by the training module 830, validation module 840, and the inference module 850. The datastore 860 may also store VAE encoder and VAE decoder parameters used as teacher models for knowledge distillation, as well as trained parameters of the latent projector, latent merge block, and latent deprojector for each designated tap point in the ISP pipeline. The datastore 860 may also store other data generated by the training module 830 and validation module 840, such as the hyperparameters for training deep neural networks, internal parameters of trained deep neural networks (e.g., values of tunable parameters of activation functions, such as Fractional Adaptive Linear Units (FALUs)), etc. In the embodiment of FIG. 8, the datastore 860 is a component of the deep learning system 800. In other embodiments, the datastore 860 may be external to the deep learning system 800 and communicate with the deep learning system 800 through a network.

In general, an untrained or insufficiently trained hybrid image processing model 820 would fail to produce output video in which AI-generated content is naturally and seamlessly incorporated into the original video frames, resulting in visible artifacts such as border discontinuities, color mismatches, or temporal flickering.

For hybrid image processing model 820 training, the input can include an input image frame and corresponding training targets, such as knowledge distillation targets from the VAE encoder and VAE decoder or labeled ground-truth processed images for end-to-end training. In various examples, the input image frame is received at an image processing system, such as the hybrid image processing system 100 and/or the hybrid image processing model 820. In other examples, the input image frame can be received at the training module 830 or the inference module 850 of FIG. 8. The imager can be a camera, such as a video camera. The input image frame can be a still image from the video camera feed. The input image frame can include a matrix of pixels, each pixel having a color, lightness, and/or other parameter. The input image frame can be downscaled and processed by a pre-processing block. Various steps can be repeated to further adjust the hybrid image processing model 820 parameters. In some examples, the training can be repeated with a new input image frame and corresponding training targets.

### Example Computing Device

FIG. 9 is a block diagram of an example computing device 900, in accordance with various embodiments. In some embodiments, the computing device 900 may be used for at least part of the deep learning system 800 in FIG. 8. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include a video input device 918 or a video output device 908, but may include video input or output device interface circuitry (e.g., connectors and supporting circuitry) to which a video input device 918 or a video output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high-bandwidth memory (HBM), flash memory, solid-state memory, and/or a hard drive. In some embodiments, the memory 904 may include memory that shares a die with the processing device 902. In some embodiments, the memory 904 includes one or more non-transitory computer-readable media storing instructions executable for image harmonization, e.g., the method 700 described above in conjunction with FIG. 7 or some operations performed by the DNN system 800 in FIG. 8. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a non-solid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include a video output device 908 (or corresponding interface circuitry, as discussed above). The video output device 908 may include any device that generates an audible indicator, such as speakers, headsets, or earbuds, for example.

The computing device 900 may include a video input device 918 (or corresponding interface circuitry, as discussed above). The video input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### SELECTED EXAMPLES

The following paragraphs provide various examples of the embodiments disclosed herein.
Example 1 provides an apparatus, including a computer processor for executing computer program instructions; and a non-transitory computer-readable memory storing computer program instructions executable by the computer processor to perform operations including receiving image data from a first processing block of an image signal processing (ISP) pipeline at a latent projector; projecting, at the latent projector, the image data from an image space representation to a latent space representation, where the latent space representation corresponds to a latent space of a diffusion model; generating, at the diffusion model, a diffusion latent output in the latent space; merging, at a latent merge block, the latent space representation of the image data with the diffusion latent output to generate a merged latent representation; converting, at a latent deprojector, the merged latent representation from the latent space to the image space representation to generate a deprojected image; and providing the deprojected image to a second processing block of the ISP pipeline.
Example 2 provides the apparatus of example 1, where generating the diffusion latent output includes generating the diffusion latent output based at least in part on one or more conditioning signals.
Example 3 provides the apparatus of example 2, where the one or more conditioning signals include textual prompt embeddings generated by a text encoder and injected into the diffusion model via cross-attention layers.
Example 4 provides the apparatus of example 3, where the text encoder includes a transformer and converts raw text to a high-dimensional embedding space
Example 5 provides the apparatus of any one of examples 1-4, where the first processing block and the second processing block are sequential processing blocks in the ISP pipeline.
Example 6 provides the apparatus of any one of examples 1-5, where the first processing block and the second processing block are non-sequential processing blocks in the ISP pipeline.
Example 7 provides the apparatus of any one of examples 1-6, where the latent projector includes a first convolutional neural network trained to approximate a variational autoencoder (VAE) encoder of the diffusion model, and where the latent deprojector includes a second convolutional neural network trained to approximate a VAE decoder of the diffusion model.
Example 8 provides the apparatus of example 7, where the first convolutional neural network and the second convolutional neural network are trained via knowledge distillation.
Example 9 provides the apparatus of any one of examples 1-8, where the image data received from the first processing block has a channel depth determined by a position of the first processing block within the ISP pipeline.
Example 10 provides the apparatus of example 9, where the channel depth includes four channels corresponding to a Bayer color filter array pattern when the first processing block precedes a demosaicing stage of the ISP pipeline, and where the channel depth includes three channels when the first processing block follows the demosaicing stage.
Example 11 provides the apparatus of example 9 or 10, where the latent projector and the latent deprojector are each trained for the channel depth and color space characteristics of the position of the first processing block and the second processing block, respectively.
Example 12 provides the apparatus of any one of examples 1-11, where the merging includes a gated merging operation including determining a per-element blending mask based on at least one of the latent space representation of the image data and the diffusion latent output; and combining the latent space representation of the image data and the diffusion latent output according to the per-element blending mask to generate the merged latent representation.
Example 13 provides the apparatus of any one of examples 1-12, where the diffusion model generates the diffusion latent output at a temporally subsampled rate relative to a frame rate of the ISP pipeline, and where the operations further include interpolating the diffusion latent output in the latent space for frames in which the diffusion model does not generate a new diffusion latent output, the interpolating producing a semantically coherent transition between successive diffusion latent outputs.
Example 14 provides the apparatus of any one of examples 1-13, where a complexity of the latent deprojector varies based on a position of the second processing block within the ISP pipeline, the latent deprojector having a greater number of parameters and multiply-accumulate operations when the second processing block is at a later stage of the ISP pipeline than when the second processing block is at an earlier stage of the ISP pipeline.
Example 15 provides the apparatus of any one of examples 1-14, where the operations further include identifying static regions and dynamic regions within the image data; restricting the generating of the diffusion latent output to the dynamic regions; and reusing a cached diffusion latent output for the static regions during the merging, where the static regions and dynamic regions are determined based on temporal changes between successive frames of a video stream processed by the ISP pipeline.
Example 16 provides one or more non-transitory computer-readable media storing instructions executable to perform operations, the operations including receiving image data from a first processing block of an image signal processing (ISP) pipeline at a latent projector; projecting, at the latent projector, the image data from an image space representation to a latent space representation, where the latent space representation corresponds to a latent space of a diffusion model; generating, at the diffusion model, a diffusion latent output in the latent space; merging, at a latent merge block, the latent space representation of the image data with the diffusion latent output to generate a merged latent representation; converting, at a latent deprojector, the merged latent representation from the latent space to the image space representation to generate a deprojected image; and providing the deprojected image to a second processing block of the ISP pipeline.
Example 17 provides the one or more non-transitory computer-readable media of example 16, where generating the diffusion latent output includes generating the diffusion latent output based at least in part on one or more conditioning signals.
Example 18 provides the one or more non-transitory computer-readable media of example 17, where the one or more conditioning signals include textual prompt embeddings generated by a text encoder and injected into the diffusion model via cross-attention layers.
Example 19 provides the one or more non-transitory computer-readable media of example 18, where the text encoder includes a transformer and converts raw text to a high-dimensional embedding space.
Example 20 provides the one or more non-transitory computer-readable media of any one of examples 16-19, where the first processing block and the second processing block are sequential processing blocks in the ISP pipeline.
Example 21 provides the one or more non-transitory computer-readable media of any one of examples 16-20, where the first processing block and the second processing block are non-sequential processing blocks in the ISP pipeline.
Example 22 provides the one or more non-transitory computer-readable media of any one of examples 16-21, where the latent projector includes a first convolutional neural network trained to approximate a variational autoencoder (VAE) encoder of the diffusion model, and where the latent deprojector includes a second convolutional neural network trained to approximate a VAE decoder of the diffusion model.
Example 23 provides the one or more non-transitory computer-readable media of example 22, where the first convolutional neural network and the second convolutional neural network are trained via knowledge distillation.
Example 24 provides the one or more non-transitory computer-readable media of any one of examples 16-23, where the image data received from the first processing block has a channel depth determined by a position of the first processing block within the ISP pipeline.
Example 25 provides the one or more non-transitory computer-readable media of example 24, where the channel depth includes four channels corresponding to a Bayer color filter array pattern when the first processing block precedes a demosaicing stage of the ISP pipeline, and where the channel depth includes three channels when the first processing block follows the demosaicing stage.
Example 26 provides the one or more non-transitory computer-readable media of example 24 or 25, where the latent projector and the latent deprojector are each trained for channel depth and color space characteristics of positions of the first processing block and the second processing block, respectively.
Example 27 provides the one or more non-transitory computer-readable media of any one of examples 16-26, where the merging includes a gated merging operation including determining a per-element blending mask based on at least one of the latent space representation of the image data and the diffusion latent output; and combining the latent space representation of the image data and the diffusion latent output according to the per-element blending mask to generate the merged latent representation.
Example 28 provides the one or more non-transitory computer-readable media of any one of examples 16-27, where the diffusion model generates the diffusion latent output at a temporally subsampled rate relative to a frame rate of the ISP pipeline, and where the operations further include interpolating the diffusion latent output in the latent space for frames in which the diffusion model does not generate a new diffusion latent output, the interpolating producing a semantically coherent transition between successive diffusion latent outputs.
Example 29 provides the one or more non-transitory computer-readable media of any one of examples 16-28, where a complexity of the latent deprojector varies based on a position of the second processing block within the ISP pipeline, the latent deprojector having a greater number of parameters and multiply-accumulate operations when the second processing block is at a later stage of the ISP pipeline than when the second processing block is at an earlier stage of the ISP pipeline.
Example 30 provides the one or more non-transitory computer-readable media of any one of examples 16-29, where the operations further include identifying static regions and dynamic regions within the image data; restricting the generating of the diffusion latent output to the dynamic regions; and reusing a cached diffusion latent output for the static regions during the merging, where the static regions and dynamic regions are determined based on temporal changes between successive frames of a video stream processed by the ISP pipeline.
Example 31 provides a computer-implemented method, including receiving image data from an image signal processing (ISP) pipeline at a latent projector; projecting, at the latent projector, the image data from an image space representation into a latent space representation; generating, at a diffusion model, a diffusion latent output in the latent space representation; merging, at a latent merge block, the latent space representation of the image data with the diffusion latent output, generating a merged latent representation; converting, at a latent deprojector, the merged latent representation from the latent space into the image space representation to produce a deprojected image; and providing the deprojected image to a second ISP pipeline block.
Example 32 provides the computer-implemented method of example 31, where generating the diffusion latent output includes generating the diffusion latent output based at least in part on one or more conditioning signals.
Example 33 provides the computer-implemented method of example 32, where the one or more conditioning signals include textual prompt embeddings generated by a text encoder and injected into the diffusion model via cross-attention layers.
Example 34 provides the computer-implemented method of example 33, where the text encoder includes a transformer and converts raw text to a high-dimensional embedding space.
Example 35 provides the computer-implemented method of any one of examples 31-34, where the first processing block and the second processing block are sequential processing blocks in the ISP pipeline.
Example 36 provides the computer-implemented method of any one of examples 31-35, where the first processing block and the second processing block are non-sequential processing blocks in the ISP pipeline.
Example 37 provides the computer-implemented method of any one of examples 31-36, where the latent projector includes a first convolutional neural network trained to approximate a variational autoencoder (VAE) encoder of the diffusion model, and where the latent deprojector includes a second convolutional neural network trained to approximate a VAE decoder of the diffusion model.
Example 38 provides the computer-implemented method of example 37, where the first convolutional neural network and the second convolutional neural network are trained via knowledge distillation.
Example 39 provides the computer-implemented method of any one of examples 31-38, where the image data received from the first processing block has a channel depth determined by a position of the first processing block within the ISP pipeline.
Example 40 provides the computer-implemented method of example 39, where the channel depth includes four channels corresponding to a Bayer color filter array pattern when the first processing block precedes a demosaicing stage of the ISP pipeline, and where the channel depth includes three channels when the first processing block follows the demosaicing stage.
Example 41 provides the computer-implemented method of example 39 or 40, where the latent projector and the latent deprojector are each trained for channel depth and color space characteristics corresponding to positions of the first processing block and the second processing block, respectively.
Example 42 provides the computer-implemented method of any one of examples 31-41, where the merging includes a gated merging operation including determining a per-element blending mask based on at least one of the latent space representation of the image data and the diffusion latent output; and combining the latent space representation of the image data and the diffusion latent output according to the per-element blending mask to generate the merged latent representation.
Example 43 provides the computer-implemented method of any one of examples 31-42, where the diffusion model generates the diffusion latent output at a temporally subsampled rate relative to a frame rate of the ISP pipeline, and where the method further includes interpolating the diffusion latent output in the latent space for frames in which the diffusion model does not generate a new diffusion latent output, the interpolating producing a semantically coherent transition between successive diffusion latent outputs.
Example 44 provides the computer-implemented method of any one of examples 31-43, where a complexity of the latent deprojector varies based on a position of the second processing block within the ISP pipeline, the latent deprojector having a greater number of parameters and multiply-accumulate operations when the second processing block is at a later stage of the ISP pipeline than when the second processing block is at an earlier stage of the ISP pipeline.
Example 45 provides the computer-implemented method of any one of examples 31-44, further including identifying static regions and dynamic regions within the image data; restricting generation of the diffusion latent output to the dynamic regions; and reusing a cached diffusion latent output for the static regions during the merging, where the static regions and dynamic regions are determined based on temporal changes between successive frames of a video stream processed by the ISP pipeline.
Example 46 provides an apparatus, including an image signal processing (ISP) pipeline including a plurality of sequentially arranged processing blocks configured to transform raw sensor data into an output image; a latent projector positioned at a selectable location within the ISP pipeline and configured to project image data output by a first processing block of the ISP pipeline from an image space representation into a latent space representation corresponding to a latent space of a diffusion model; a latent merge block configured to receive the latent space representation from the latent projector and a diffusion latent output from the diffusion model and to combine the latent space representation and the diffusion latent output to produce a merged latent representation; and a latent deprojector configured to convert the merged latent representation from the latent space into the image space representation to produce a deprojected image for provision to a second processing block of the ISP pipeline.
Example 47 provides the apparatus of example 46, where the latent projector includes a convolutional neural network trained to approximate a variational autoencoder (VAE) encoder of the diffusion model.
Example 48 provides the apparatus of example 46 or 47, where the latent deprojector includes a convolutional neural network trained to approximate a VAE decoder of the diffusion model.
Example 49 provides the apparatus of example 46 or 47, where the selectable location is determined based on a type of content to be merged into the image data.
Example 50 provides an apparatus, comprising an image signal processing (ISP) pipeline including a first processing block and a second processing block; a latent projector configured to receive image data from the first processing block and project the image data from an image space representation to a latent space representation; a diffusion model having a latent space, wherein the latent space representation corresponds to the latent space, and wherein the diffusion model is configured to generate a diffusion latent output in the latent space; a latent merge block configured to merge the latent space representation of the image data with the diffusion latent output to generate a merged latent representation; and a latent deprojector configured to convert the merged latent representation from the latent space to the image space representation to generate a deprojected image; wherein the deprojected image is provided to the second processing block of the ISP pipeline.
Example 51 provides an apparatus, including an image signal processing (ISP) pipeline including a first processing block and a second processing block; a latent projector configured to receive image data from the first processing block and project the image data from an image space representation to a latent space representation, where the latent space representation corresponds to the latent space of a diffusion model; a latent merge block configured to merge the latent space representation of the image data with a diffusion latent output from the diffusion model to generate a merged latent representation; and a latent deprojector configured to convert the merged latent representation from the latent space to the image space representation to generate a deprojected image for providing to the second processing block of the ISP pipeline.
Example 52 provides the apparatus of example 51, where the diffusion model is configured to generate the diffusion latent output in the latent space.
Example 53 provides the apparatus of example 52, where generating the diffusion latent output includes generating the diffusion latent output based at least in part on one or more conditioning signals.
Example 54 provides the apparatus of example 53, where the one or more conditioning signals include textual prompt embeddings generated by a text encoder and injected into the diffusion model via cross-attention layers.
Example 55 provides the apparatus of any of examples 51-54, where the ISP pipeline is configured to transform raw sensor data into an output video including a sequence of output frames, where the diffusion model generates the diffusion latent output once every N frames, where N is greater than 1.
Example 56 provides the apparatus of any of examples 51-55, where the ISP pipeline is configured to transform raw sensor data into an output video including a sequence of output frames, where the diffusion model generates the diffusion latent output at a temporally subsampled rate relative to a frame rate of the ISP pipeline.
Example 57 provides the apparatus of any of examples 55 and 56, where for frames having no new corresponding diffusion latent output, the latent merge block combines the latent space representation with one of: an interpolated diffusion latent output based on temporally adjacent diffusion latent outputs in the latent space, and an extrapolated diffusion latent output computed from one or more prior diffusion latent outputs.
Example 58 provides the apparatus of any of examples 51-57, further including a spatial masking module configured to identify static regions in the image data and dynamic regions in the image data based on temporal changes between successive frames.
Example 59 provides the apparatus of example 58, where the latent merge block is configured to: combine the latent space representation with the diffusion latent output for the dynamic regions, and combine the latent space representation with a cached diffusion latent output for the static regions.
Example 60 provides the apparatus of any of examples 51-59, wherein the latent merge block combines the latent space representation of the image data and the diffusion latent output to produce a combined latent representation using an alpha blending operation that applies a blending coefficient to linearly weight a contribution of the latent space representation of the image data relative to a contribution of the diffusion latent output, such that the contributions of the latent space representation of the image data and the diffusion latent output sum to unity.
Example 61 provides the apparatus of example 60, where the blending coefficient is a separate value per channel of the latent space representation.
Example 62 provides the apparatus of any of examples 51-59, where the latent merge block combines the latent space representation of the image data and the diffusion latent output to generate a combined latent representation by concatenating the latent space representation and the diffusion latent output along a channel dimension and applying a learned convolutional filter to the concatenation.
Example 63 provides the apparatus of example 62, where the learned convolutional filter includes a 3×3 two-dimensional convolution.
Example 64 provides the apparatus of any of examples 51-59, where the merging includes a gated merging operation including determining a per-element blending mask based on at least one of the latent space representation of the image data and the diffusion latent output; and combining the latent space representation of the image data and the diffusion latent output according to the per-element blending mask to generate the merged latent representation.
Example 65 provides the apparatus of any of examples 51-59, where the latent merge block combines the latent space representation and the diffusion latent output to generate a combined latent representation using a cross-attention operation in which the latent space representation serves as a query and the diffusion latent output provides keys and values.
Example 66 provides the apparatus of any of examples 51-65, where the first processing block and the second processing block are sequential processing blocks in the ISP pipeline.
Example 67 provides the apparatus of any of examples 51-65, where the first processing block and the second processing block are non-sequential processing blocks in the ISP pipeline.
Example 68 provides the apparatus of any of examples 51-67, where the latent projector includes a first convolutional neural network trained to approximate a variational autoencoder (VAE) encoder of the diffusion model, and where the latent deprojector includes a second convolutional neural network trained to approximate a VAE decoder of the diffusion model.
Example 69 provides the apparatus of example 68, where the first convolutional neural network and the second convolutional neural network are trained via knowledge distillation.
Example 70 provides the apparatus of any of examples 51-69, where the image data received from the first processing block has a channel depth determined by a position of the first processing block within the ISP pipeline.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus, comprising:
an image signal processing (ISP) pipeline including a first processing block and a second processing block;
a latent projector configured to receive image data from the first processing block and project the image data from an image space representation to a latent space representation, wherein the latent space representation corresponds to the latent space of a diffusion model;
a latent merge block configured to merge the latent space representation of the image data with a diffusion latent output from the diffusion model to generate a merged latent representation; and
a latent deprojector configured to convert the merged latent representation from the latent space to the image space representation to generate a deprojected image for providing to the second processing block of the ISP pipeline.

2. The apparatus of claim 1, wherein the diffusion model is configured to generate the diffusion latent output in the latent space.

3. The apparatus of claim 2, wherein generating the diffusion latent output includes generating the diffusion latent output based at least in part on one or more conditioning signals.

4. The apparatus of claim 1, wherein the first processing block and the second processing block are sequential processing blocks in the ISP pipeline.

5. The apparatus of claim 1, wherein the first processing block and the second processing block are non-sequential processing blocks in the ISP pipeline.

6. The apparatus of claim 1, wherein the latent projector includes a first convolutional neural network trained to approximate a variational autoencoder (VAE) encoder of the diffusion model, and wherein the latent deprojector includes a second convolutional neural network trained to approximate a VAE decoder of the diffusion model.

7. The apparatus of claim 6, wherein the first convolutional neural network and the second convolutional neural network are trained via knowledge distillation.

8. The apparatus of claim 1, wherein the image data received from the first processing block has a channel depth determined by a position of the first processing block within the ISP pipeline.

9. The apparatus of claim 1, wherein the merging includes a gated merging operation comprising:
determining a per-element blending mask based on at least one of the latent space representation of the image data and the diffusion latent output; and
combining the latent space representation of the image data and the diffusion latent output according to the per-element blending mask to generate the merged latent representation.

10. The apparatus of claim 1, wherein the ISP pipeline is configured to transform raw sensor data into an output video comprising a sequence of output frames, wherein the diffusion model generates the diffusion latent output once every N frames, where N is greater than 1.

11. The apparatus of claim 10, wherein for frames having no new corresponding diffusion latent output, the latent merge block combines the latent space representation with one of:
an interpolated diffusion latent output based on temporally adjacent diffusion latent outputs in the latent space, and
an extrapolated diffusion latent output determined based on one or more previous diffusion latent outputs.

12. The apparatus of claim 1, further comprising a spatial masking module configured to identify static regions in the image data and dynamic regions in the image data based on temporal changes between successive frames.

13. The apparatus of claim 12, wherein the latent merge block is configured to:
for the dynamic regions: combine the latent space representation with the diffusion latent output; and
for the static regions: combine the latent space representation with a cached diffusion latent output.

14. The apparatus of claim 1, wherein the latent merge block combines the latent space representation of the image data and the diffusion latent output to generate a combined latent representation, wherein the latent merge block uses an alpha blending operation that applies a blending coefficient to linearly weight a contribution of the latent space representation of the image data relative to a contribution of the diffusion latent output, such that the contributions of the latent space representation of the image data and the diffusion latent output sum to unity.

15. The apparatus of claim 1, wherein the latent merge block combines the latent space representation of the image data and the diffusion latent output to generate a combined latent representation by concatenating the latent space representation and the diffusion latent output along a channel dimension and applying a learned convolutional filter to the concatenation.

16. The apparatus of claim 1, wherein the latent merge block combines the latent space representation and the diffusion latent output to generate a combined latent representation using a cross-attention operation in which the latent space representation serves as a query and the diffusion latent output provides keys and values.

17. One or more non-transitory computer-readable media storing instructions executable to perform operations, the operations comprising:
receiving image data from a first processing block of an image signal processing (ISP) pipeline at a latent projector;
projecting, at the latent projector, the image data from an image space representation to a latent space representation, wherein the latent space representation corresponds to a latent space of a diffusion model;
merging, at a latent merge block, the latent space representation of the image data with a diffusion latent output to generate a merged latent representation;
converting, at a latent deprojector, the merged latent representation from the latent space to the image space representation to generate a deprojected image for providing to a second processing block of the ISP pipeline.

18. The one or more non-transitory computer-readable media of claim 17, the operations further comprising generating, at the diffusion model, a diffusion latent output in the latent space.

19. The one or more non-transitory computer-readable media of claim 17, wherein the first processing block and the second processing block are one of: sequential processing blocks in the ISP pipeline, and non-sequential processing blocks in the ISP pipeline.

20. A computer-implemented method, comprising:
receiving image data from a first processing block of an image signal processing (ISP) pipeline at a latent projector;
projecting, at the latent projector, the image data from an image space representation into a latent space representation;
generating, at a diffusion model, a diffusion latent output in the latent space representation;
merging, at a latent merge block, the latent space representation of the image data with the diffusion latent output, to generate a merged latent representation; and
converting, at a latent deprojector, the merged latent representation from the latent space into the image space representation to generate a deprojected image for providing to a second ISP pipeline block.
